(19) United States
(12) Patent Application Publication
(10) Pub. No.: US 2026/0162090 A1
(43) Pub. Date: Jun. 11, 2026

(54) METHOD, APPARATUS, DEVICE, AND STORAGE MEDIUM FOR ELECTRONIC PAYMENT

(71) Applicant: Beijing Zitiao Network Technology Co., Ltd., Beijing (CN)

(72) Inventors: Xiaodan YANG, Beijing (CN); Jingying Yuan, Beijing (CN)

(21) Appl. No.: 19/339,207

(22) Filed: Sep. 24, 2025

(30) Foreign Application Priority Data
Dec. 10, 2024 (CN) 202411813089.3

(51) Int. Cl. G06Q 20/10; G06Q 20/14; G06Q 20/22

(52) U.S. Cl. CPC G06Q 20/102; G06Q 20/14; G06Q 20/29

(57) ABSTRACT

According to embodiments of the disclosure, a method, an apparatus, a device, and a computer-readable storage medium for electronic payment are provided. A method includes: presenting, at a first device, a set of candidate objects in response to a selection of a first entry associated with an order; and triggering, based on a selection of at least one object from the set of candidate objects, a second device associated with the at least one object to present a first reminder message associated with the order, the first reminder message including first description information of the order and second description information of a transaction object associated with the order, the first description information indicating a payment amount associated with the order.

### CROSS-REFERENCE

The present application claims priority to Chinese Patent Application No. 202411813089.3, filed on Dec. 10, 2024, and entitled “METHOD, APPARATUS, DEVICE, AND STORAGE MEDIUM FOR ELECTRONIC PAYMENT”, which is incorporated herein by reference in its entirety.

### FIELD

Example embodiments of the present disclosure generally relate to the field of computers, and in particular, to a method, an apparatus, a device, and a computer-readable storage medium for electronic payment.

### BACKGROUND

Electronic commerce has become an indispensable part of people's daily life. Through electronic commerce, people may obtain various desired objects, including but not limited to, commodities, services, and the like. A payment procedure is an important component of electronic commerce. In real life, in many scenarios, other users may be needed to assist in completing a payment. In operation, a platform may send a payment request of a user to terminal devices of other users. However, in a traditional solution, a prompt message may only display information about an amount to be paid, and the user needs to trigger a further viewing/jumping operation to obtain details of an order to be paid. In other words, the interaction procedure of the traditional electronic payment is relatively complicated and lacks friendliness. Therefore, the traditional electronic payment procedure needs to be further improved.

### SUMMARY

In a first aspect of the present disclosure, a method for electronic payment is provided. The method includes: presenting, at a first device, a set of candidate objects in response to a selection of a first entry associated with an order; and triggering, based on a selection of at least one object from the set of candidate objects, a second device associated with the at least one object to present a first reminder message associated with the order, the first reminder message including first description information of the order and second description information of a transaction object associated with the order, the first description information indicating a payment amount associated with the order.

In a second aspect of the present disclosure, a method for electronic payment is provided. The method includes: presenting, at a second device, a first reminder message associated with an order in response to reception of a selection of a first user associated with the second device at a first device, the first reminder message including first description information of the order and second description information of a transaction object associated with the order, the first description information indicating a payment amount associated with the order; and paying at least a portion of the payment amount associated with the order based on a preset operation on the first reminder message.

In a third aspect of the present disclosure, an apparatus for electronic payment is provided. The apparatus includes: a candidate object selection module configured to present, at a first device, a set of candidate objects in response to a selection of a first entry associated with an order, the set of candidate objects including user objects and/or group objects; and a reminder message trigger module configured to trigger, based on a selection of at least one object from the set of candidate objects, a second device associated with the at least one object to present a first reminder message associated with the order, the first reminder message including first description information of the order and second description information of a transaction object associated with the order, the first description information indicating a payment amount associated with the order.

In a fourth aspect of the present disclosure, an apparatus for electronic payment is provided. The apparatus includes: a presentation module configured to present, at a second device, a first reminder message associated with an order in response to reception of a selection of a first user associated with the second device at a first device, the first reminder message including first description information of the order and second description information of a transaction object associated with the order, the first description information indicating a payment amount associated with the order; and a payment module configured to pay at least a portion of the payment amount associated with the order based on a preset operation on the first reminder message.

In a fifth aspect of the present disclosure, an electronic device is provided. The device includes at least one processor; and at least one memory, the at least one memory is coupled to the at least one processor and storing instructions executable by the at least one processor, the instructions, when executed by the at least one processor, cause the device to perform the method of the first aspect.

In a sixth aspect of the present disclosure, an electronic device is provided. The device includes at least one processor; and at least one memory, the at least one memory is coupled to the at least one processor and storing instructions executable by the at least one processor, the instructions, when executed by the at least one processor, cause the device to perform the method of the second aspect.

In a seventh aspect of the present disclosure, a computer-readable storage medium is provided. The computer-readable storage medium has a computer program stored thereon, the computer program is executable by a processor to implement the method of the first aspect.

In an eighth aspect of the present disclosure, a computer-readable storage medium is provided. The computer-readable storage medium has a computer program stored thereon, the computer program is executable by a processor to implement the method of the second aspect.

In a ninth aspect of the present disclosure, a computer program product is provided. The computer program product is tangibly stored in a computer storage medium and includes computer-executable instructions, the computer-executable instructions, when executed by a device, cause the device to perform the method of the first aspect.

In a tenth aspect of the present disclosure, a computer program product is provided. The computer program product is tangibly stored in a computer storage medium and includes computer-executable instructions, the computer-executable instructions, when executed by a device, cause the device to perform the method of the second aspect.

It should be understood that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments according to the present disclosure may be implemented;

FIG. 2A to FIG. 2F show example interfaces according to some embodiments of the present disclosure;

FIG. 3A to FIG. 3F show example interfaces according to some embodiments of the present disclosure;

FIG. 4A to FIG. 4F show example interfaces according to some embodiments of the present disclosure;

FIG. 5 and FIG. 6 show flowcharts of example processes of electronic payment according to some embodiments of the present disclosure;

FIG. 7 and FIG. 8 show schematic structural block diagrams of example apparatuses for electronic payment according to some embodiments of the present disclosure; and

FIG. 9 shows a block diagram of an electronic device capable of implementing multiple embodiments of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein; on the contrary, these embodiments are provided for a more thorough and complete understanding of the present disclosure. It should be understood that the drawings and embodiments of the present disclosure are only for illustrative purposes and are not intended to limit the protection scope of the present disclosure.

In the description of the embodiments of the present disclosure, the term “include/comprise” and similar terms thereof should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other definitions, either explicit or implicit, may also be included below.

Herein, unless explicitly stated, the step executed “in response to A” does not mean that the step is executed immediately after “A”, but may include one or more intermediate steps.

It may be understood that the data involved in the technical solution (including but not limited to the data itself, acquisition or use of the data) should comply with requirements of corresponding laws, regulations and related provisions.

It may be understood that before using the technical solution disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, in response to reception of an active request from a user, prompt information is sent to the user to clearly inform the user that the requested operation will require access to and use of personal information of the user, so that the user may independently choose, based on the prompt information, whether to provide the personal information to software or hardware, such as an electronic device, an application, a server, or a storage medium, that performs the operations of the technical solution of the present disclosure.

As an optional but non-limiting implementation, in response to the reception of the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other manners that satisfy the relevant laws and regulations may also be applied in the implementations of the present disclosure.

As used herein, the term “model” may learn a correlation between corresponding inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, a “model” may also be referred to as a “machine learning model”, a “learning model”, a “machine learning network”, or a “learning network”, which terms are used interchangeably herein.

A “neural network” is a machine learning network based on deep learning. A neural network may process an input and provide a corresponding output, and generally includes an input layer and an output layer, as well as one or more hidden layers between the input layer and the output layer. Neural networks used in deep learning applications typically include many hidden layers, thereby increasing the depth of the network. The layers of the neural network are connected in sequence, so that the output of the previous layer is provided as the input of the next layer, where the input layer receives the input of the neural network, and the output of the output layer serves as the final output of the neural network. Each layer of the neural network includes one or more nodes (also referred to as processing nodes or neurons), each of which processes the input from the previous layer.

Generally, machine learning may roughly include three stages, namely, a training stage, a testing stage, and an application stage (also referred to as an inference stage). In the training stage, a given model may be trained using a large amount of training data, and a parameter value may be continuously updated through iteration until the model may obtain consistent inference that meets an expected objective from the training data. Through training, the model may be considered to be capable of learning a correlation (also referred to as a mapping from input to output) from input to output from the training data. The parameter value of the trained model is determined. In the testing stage, a test input is applied to the trained model to test whether the model may provide a correct output, thereby determining the performance of the model. The testing stage may sometimes be merged with the training stage. In the application or inference stage, the trained model may be used to process an actual model input based on the parameter value obtained through training, to determine a corresponding model output.

As mentioned above, electronic commerce has become an indispensable part of daily life of people. Through electronic commerce, people may obtain various desired objects, including but not limited to, commodities, services, and the like. A payment procedure is an important component of electronic commerce. In real life, in many scenarios, other users may be needed to assist in completing a payment. In operations, a platform may send a payment request of a user to terminal devices of other users. However, in a traditional solution, a prompt message may only display information about an amount to be paid, and the user needs to trigger a further viewing/jumping operation to obtain details of an order to be paid. In other words, the interaction procedure of the traditional electronic payment is relatively complicated and lacks friendliness. Therefore, the traditional electronic payment procedure needs to be further improved.

Embodiments of the present disclosure provide a solution for electronic payment. The solution includes: presenting a set of candidate objects in response to a selection of a first entry associated with an order, the set of candidate objects including user objects and/or group objects; and triggering, based on a selection of at least one object from the set of candidate objects, a second device associated with the at least one object to present a first reminder message associated with the order, the first reminder message including first description information of the order and second description information of a transaction object associated with the order, the first description information indicating a payment amount associated with the order. In this way, the candidate objects may better understand the order information to determine whether to assist in completing the payment operation.

It should be understood that the term “object” in the present disclosure refers to any object that may be traded through an electronic platform, including real objects and virtual objects, for example, including but not limited to, commodities, virtual resources, and/or services. In short, the present disclosure is not limited in terms of the specific form of the object.

It should be understood that in the present disclosure, the user may pay for the order through any virtual resources, such as virtual currency in an account, a coupon, a discount coupon, and/or a red envelope.

Various example implementations of the solution are described in detail below in further conjunction with the drawings.

### Example Environment

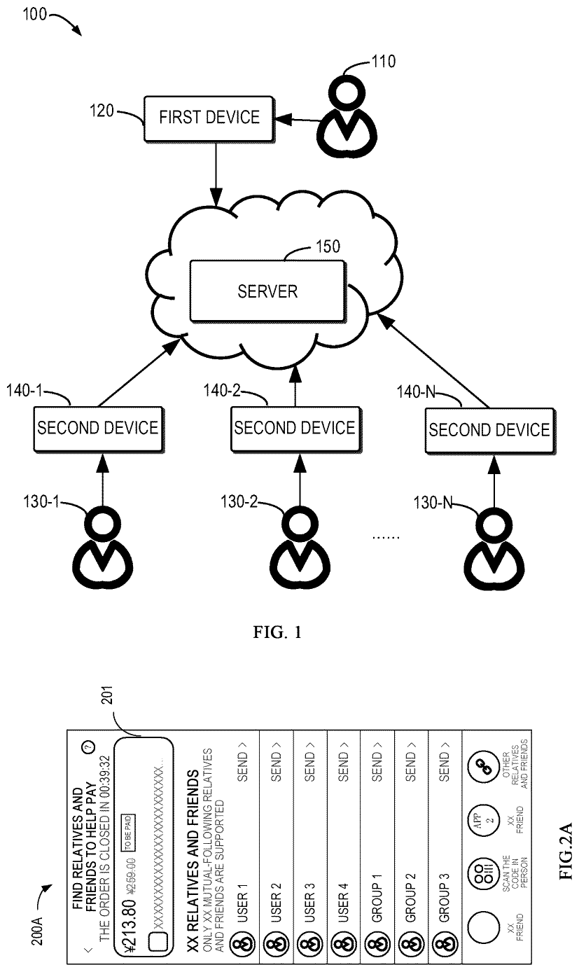

FIG. 1 shows a schematic diagram of an example environment 100 in which the embodiments of the present disclosure may be implemented. The environment 100 includes multiple users, for example, a user 110, a user 130-1, a user 130-2, and a user 130-N, where N is a positive integer greater than or equal to 1. For the convenience of discussion, the user 110 may be referred to as a first user 110, and the user 130-1, the user 130-2, and the user 130-N may be collectively or individually referred to as a second user 130.

The environment 100 may further include a first device 120 corresponding to the first user 110, and second devices 140-1, 140-2 to 140-N corresponding to the second user 130. For the convenience of discussion, the second devices 140-1, 140-2 to 140-N may be collectively or individually referred to as a second device 140.

In some embodiments, the first user 110 may initiate an acquisition of one or more objects through the first device 120, for example, purchase one or more objects, to trigger the generation of an order. In some scenarios, the first user 110 may request one or more of the second users 130 to assist in completing the payment of the order. For the above scenarios, the first user 110 is sometimes also referred to as a requester, and the second user 130 is also referred to as a responder.

In this example environment 100, an application may be installed on the first device 120 and the second device 140. The first user 110 and the second user 130 may interact with the application via the first device 120 and the second device 140 and/or attached devices of the first device 120 and the second device 140.

The application may provide the user with an integration of multiple applications or components on the first device 120/second device 140. These applications may be used as application modules in the application. In some embodiments, the application may be downloaded and installed on the first device 120/second device 140 as an application. In some embodiments, the application may also be accessed in other ways, such as through a web page.

The application may be any appropriate type of application that may provide media content, examples of which may include but are not limited to: social applications, audio/video applications, media item playback applications, broadcast applications, and the like, and the embodiments of the present disclosure are not limited in this regard.

In the environment 100 of FIG. 1, if the application is active, the first device 120/second device 140 may present an interactive page through the application. The interactive page may be any appropriate type of page, which may support the first user 110/second user 130 to input any appropriate type of data and present any media item type of media item to the first user 110/second user 130. The interactive interface may include various interfaces that may be provided by the application 155, such as a chat interface, an editing interface, and a posting interface that present chat content.

In some embodiments, the first device 120/second device 140 may communicate with the server 150 to implement the supply of the services of the application. The first device 120/second device 140 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including the accessories and peripherals of these devices, or any combination thereof. In some embodiments, the terminal device 150 may also support any type of user interface (such as a “wearable” circuit, etc.).

The server 150 may be an independent physical server, a server cluster or a distributed system composed of multiple physical servers, or a server that provides basic cloud computing services such as cloud services, cloud databases, cloud computing, cloud functions, cloud storage, network services, cloud communications, middleware services, domain name services, security services, content delivery networks, and big data and artificial intelligence platforms. cloud server. The server 150 may include, for example, a computing system/server, such as a mainframe, an edge computing node, a computing device in a cloud environment, and the like.

A communication connection may be established between the server 150 and the first device 120/second device 140. The communication connection may be established in a wired or wireless manner. The communication connection may include but is not limited to a Bluetooth connection, a mobile network connection, a universal serial bus (USB) connection, a wireless fidelity (WiFi) connection, etc., and the embodiments of the present disclosure are not limited in this regard. In the embodiments of the present disclosure, the server 150 and the first device 120/second device 140 may implement signaling interaction through the communication connection therebetween.

The first device 120/second device 140 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a game device, or any combination thereof, including the accessories and peripherals of these devices, or any combination thereof. In some embodiments, the first device 120/second device 140 may also support any type of user interface (such as a “wearable” circuit, etc.). The server 150 may be various types of computing systems/servers that may provide computing power, including but not limited to mainframes, edge computing nodes, computing devices in cloud environments, and the like. It should be understood that the structure and function of each element in the environment 100 are described for illustrative purposes only, without implying any limitation on the scope of the present disclosure.

Various example implementations of the present disclosure are described in detail below.

### Example Interaction at the First Device

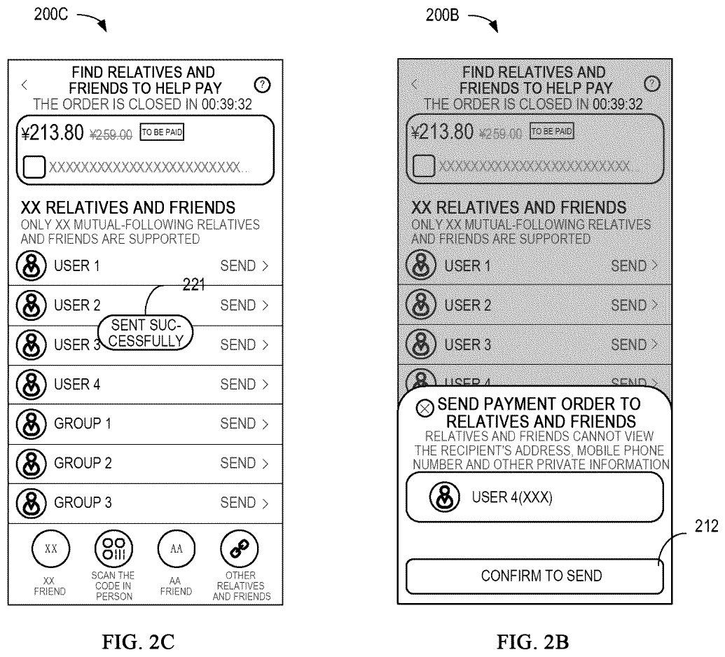

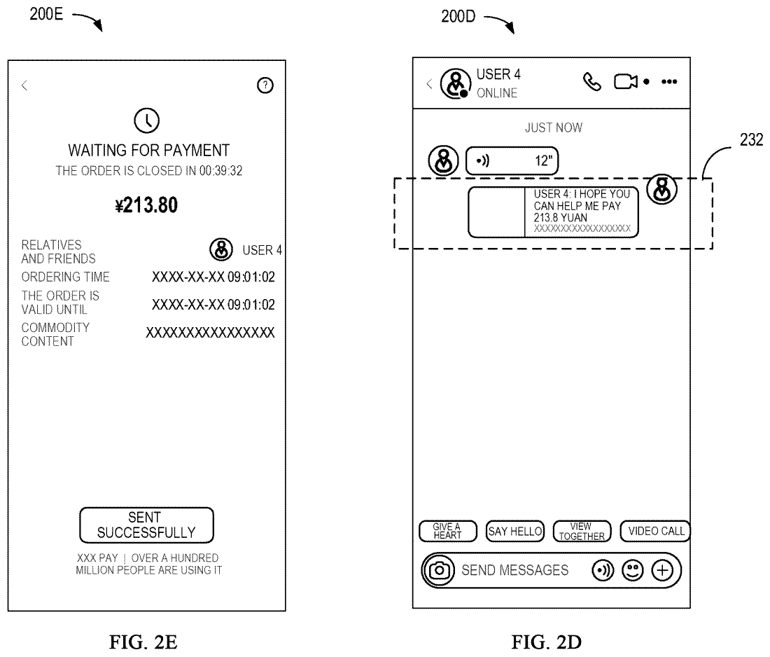

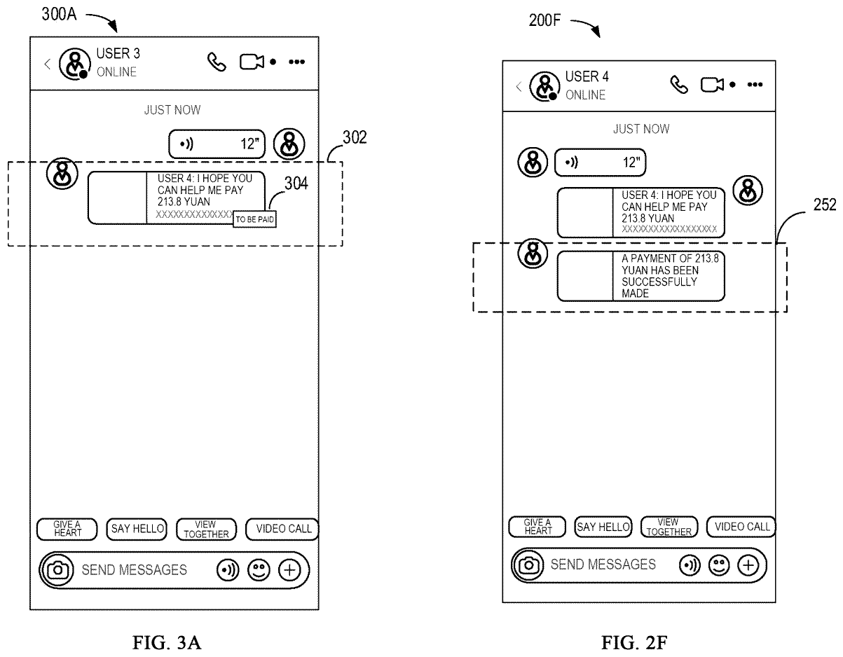

FIG. 2A to FIG. 2F show schematic diagrams of example user interfaces 200A to 200F for a requester according to some embodiments of the present disclosure. It should be understood that the pages shown in the drawings are only examples, and there may actually be various page designs. Each graphic element in the page may have different arrangements and different visual representations, one or more of which may be omitted or replaced, and there may also be one or more other elements. The embodiments of the present disclosure are not limited in this regard. The user interfaces shown in the example user interfaces 200A to 200F may be presented on the first device 120. For the convenience of discussion, the example user interfaces 200A to 200F will be described with reference to the environment 100 of FIG. 1.

In operation, the first user 110 may initiate an obtaining for one or more objects through the first device 120, for example, purchase one or more objects, to trigger the generation of an order. In some embodiments, the multiple objects obtained by the first user 110 may belong to one or more platforms/providers.

After the order is generated, the first device 120 presents a set of candidate objects in response to a selection of a first entry associated with the order. In some embodiments, the set of candidate objects may include one or more user objects and/or one or more group objects. In some embodiments, the candidate object may be the second user 130. In some embodiments, the candidate object is a user who has an association relationship with the first user 110, for example, a user followed by the first user 110, a user and the first user 110 follow each other, a friend of the first user 110, a group that the first user 110 joined, and the like.

Based on a selection of at least one object from the set of candidate objects, the first device 120 triggers a second device 140 associated with the at least one object to present a first reminder message associated with the order, where the first reminder message includes first description information of the order and second description information of a transaction object associated with the order, the first description information indicating a payment amount associated with the order. In this way, different from the traditional solution, according to the various embodiments of the present disclosure, in response to the trigger from the first user 110, the second device 140 may also present other description information related to the order, in addition to the payment amount.

In some embodiments, the second description information includes at least one of: an image identification of the transaction object, or a text description of the transaction object, such as a name of the commodity, a name of the merchant, and the like. In some embodiments, the image identification of the transaction object or the text description of the transaction object may be provided based on a machine learning model. For example, the machine learning model uses the description information of the order to summarize and generate.

As discussed above, the order may include multiple objects. In this case, the second description information may be associated with one or more of the multiple objects. In some embodiments, the second description information may be associated with an object ranked first among the multiple objects. In another embodiment, the second description information may be associated with an object with a largest amount to be paid among the multiple objects. In yet another embodiment, the second description information may relate to multiple objects, for example, the image identification of the transaction object is a jigsaw puzzle of the multiple objects, and the text description of the transaction object is a brief description of the multiple objects. It should be understood that in other embodiments, the second description information may further include any other information that describes the order. In this way, the second user 140 may quickly determine whether to assist in completing the payment of the order without additional operations. For example, if the first user 110 is a child and the desired object to be purchased is a book, and the second user 140 is a parent of the first user 110, the second user 140 may quickly determine the object to be purchased by the first user 110 through the first reminder message, thereby assisting the first user 110 to complete the payment of the order.

In some embodiments, the first reminder message also indicates time information associated with paying the order. Specifically, the first reminder message may specify how long the order will be closed. By limiting the validity time of the order, the platform may clean up the order in time, reducing the system overhead for the platform to maintain the order.

In the traditional solution, the first user 110 may only select one candidate object at a time. Only after the payment of the selected candidate object fails, a new candidate object may be selected. According to some embodiments of the present disclosure, the first user 110 may select multiple user objects and/or multiple group objects in one trigger operation. In this way, the time for the first user 110 to wait for the payment to be completed may be shortened.

In some embodiments, in response to the order being unpaid, the first device 120 may trigger, based on a selection of an additional object from the set of candidate objects, a third device associated with the additional object to present a third reminder message associated with the order. In other words, the first user 110 may initiate multiple requests to be paid in turn. In this way, the flexibility of candidate object selection is improved.

According to various embodiments of the present disclosure, the first reminder message is presented to the second user 130 in an appropriate form. In some embodiments, the first reminder message may be sent to the second device 140 in the form of an instant messaging message. In some embodiments, the first reminder message may be presented to the second device 140 in the form of a pop-up window. In some other embodiments, the first reminder message may be presented to the second device 140 in the form of a system message. In some other embodiments, the first reminder message may be inserted into a current message stream to be played. For example, the second device 140 may insert the first reminder message into a set of media content to be played. In this case, as the second user 130 swipes the screen, the second device 140 may present the first reminder message in the interactive interface. In this case, the second user 130 may choose to process the first reminder message (for example, assist in payment), or may continue to swipe the screen to ignore the first reminder message. It should be understood that the above manner of presenting the first reminder message is only illustrative. In other embodiments, the first reminder message may be presented in other forms. In the following, how to present the first reminder message will be described in more detail.

In some embodiments, based on the selection of the at least one object, the first device 120 presents, in a chat interface of a target chat, a message card associated with the order, the target chat is associated with the at least one object, the message card presenting the first description information and the second description information. By presenting the description information in the form of a card in the chat interface, it is convenient for the first user 110 to view which candidate objects are selected and to track the subsequent processing of the payment.

In some embodiments, the first reminder message includes a payment entry for paying the order. In this way, after presenting the first reminder message, the second device 140 may trigger a subsequent payment behavior.

In some embodiments, the first device 120 presents a fifth reminder message associated with a target user in response to that the order is paid by the target user associated with the at least one object. In this way, the first user 110 may obtain the payment status of the order in time. It should be understood that any payment status of the order may be presented to the first user 110, for example, the order payment fails, the order is partially paid, a candidate object that assists in paying the order, a remaining unpaid amount, an amount that has been assisted in paying, and the like.

According to some embodiments of the present disclosure, the first user 110 may set a payment mode and a total payment amount for the order amount. Example embodiments are discussed in detail below. In some embodiments, the at least one object is associated with multiple users, and each of the multiple users is associated with a partial payment amount of a total payment amount of the order. In some embodiments, the partial payment amount associated with the user is determined randomly; or the partial payment amount associated with the user is determined based on a received configuration operation.

In some embodiments, the first user 110 may pay a portion of the total order amount by himself/herself, and request one or more other candidate objects to complete the payment of the remaining portion. In this case, the first user 110 may specify a total amount paid by the one or more other candidate objects.

In some embodiments, the first user 110 may set a random mode. For example, the first user 110 may set an amount to be paid (for example, the total amount of the order or a part of the total amount of the order) and the number of candidate objects, for example, 3. In this case, the amount to be paid will be randomly divided into 3 parts, which will be paid by three candidate objects.

In some other embodiments, the first user 110 may set a fixed amount mode. For example, the first user 110 may set the number of candidate objects and the payment amount of each candidate object. For example, if the total amount to be paid is 60 yuan, it may be set that each of the 3 candidate objects pays 20 yuan.

In some other embodiments, the first user 110 may select a candidate object and limit the payment amount of each candidate object. For example, if the total amount to be paid is 60 yuan, the first user 110 may select the second users 130-1 and 130-2, and set the amount to be paid corresponding to the second user 130-1 to 20, and the amount to be paid corresponding to the second user 130-2 to 40.

It should be understood that the above example payment methods may be combined arbitrarily. In short, the first user 110 may set various parameters involved in the candidate object and the amount to be paid.

Additionally, in some embodiments, the first reminder message displayed at different second devices 140 may be different, for example, based on the amount to be paid set by the second device 140, whether the second device 140 belongs to a group, a setting mode related to the second device, and the like. In this way, the message presented at the second device 140 will be more targeted.

For a better understanding of the above process, further illustration will be made in conjunction with the example interfaces of FIG. 2A to FIG. 2F. In the example interface 200A, multiple candidate objects, users 1-4 and groups 1-3, are presented. The first user 110 may select the user 4. In response to the user 4 being selected, the interface jumps to the example interface 200B. In response to the first user 110 activating the confirmation button 212, the presentation of the first reminder information at the user 4 is triggered. In some embodiments, a sending apparatus may also be displayed at the first device 120. As shown in the example interface 200C, the interactive interface presents the prompt information 221.

In the example interface 200D, the interaction between the first user 110 and the user 4 is presented in the chat window, for example, a message card 232, where the message card 232 presents the first description information and the second description information. In some embodiments, the content of the message card 232 may be dynamically updated according to the payment status. In some embodiments, the first user 110 may trigger a click on the message card 232 to trigger a viewing of the details of the payment request, see the example interface 200E.

In some embodiments, if the user 4 completes the payment of the order, the interactive interface of the first device 120 may jump to 200F. In the example interface 200F, a second message 252 is presented, which prompts that the payment has been completed. Through the above example process, the first user 110 may flexibly request other users to assist in completing the payment for the order.

### Example Interaction at the Second Device

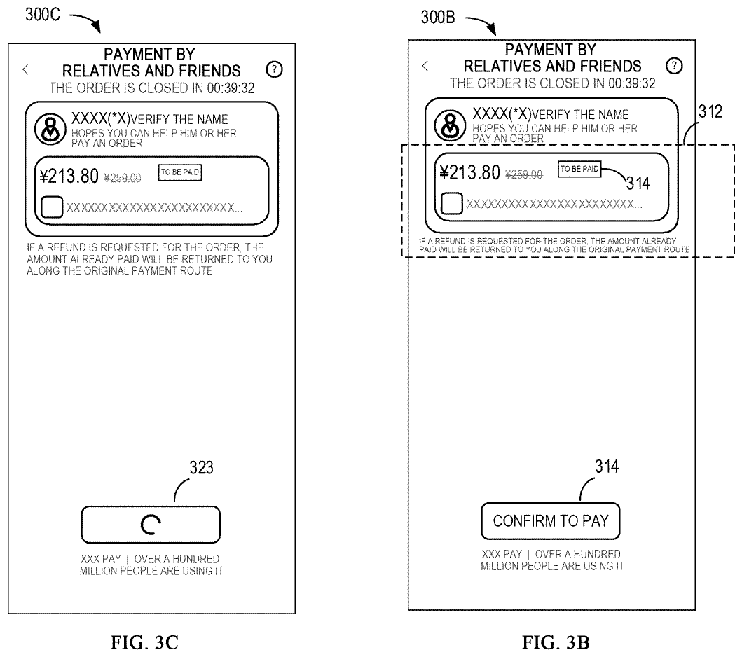

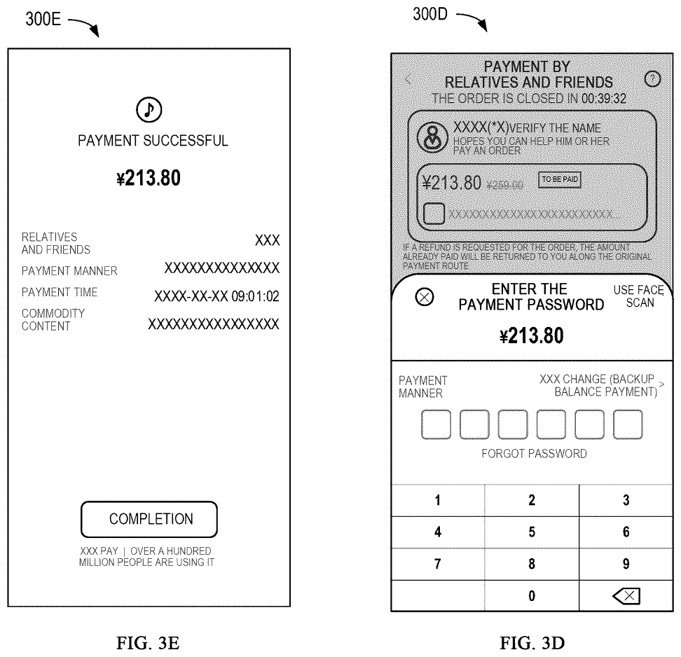

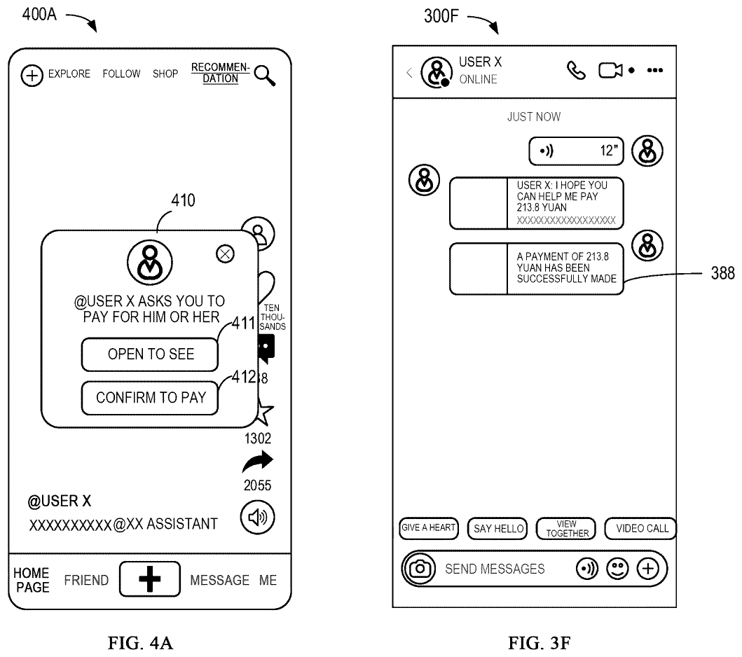

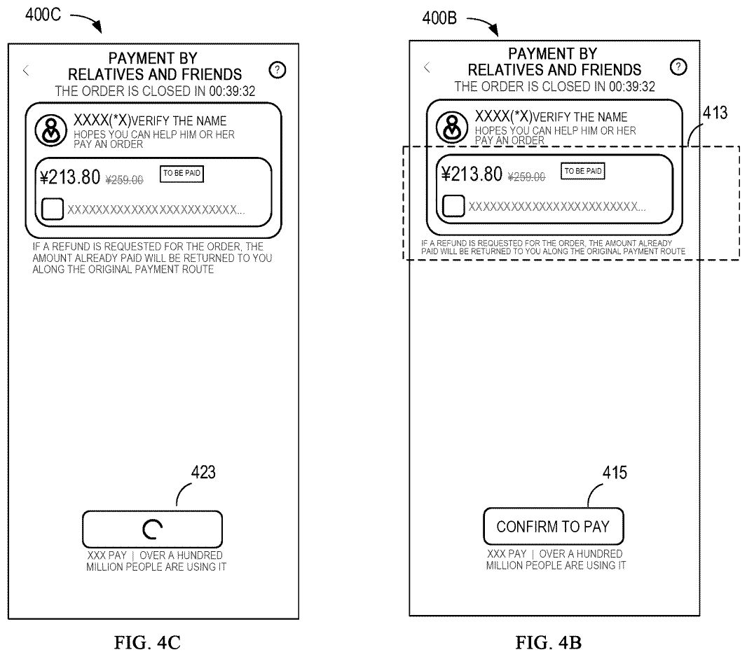

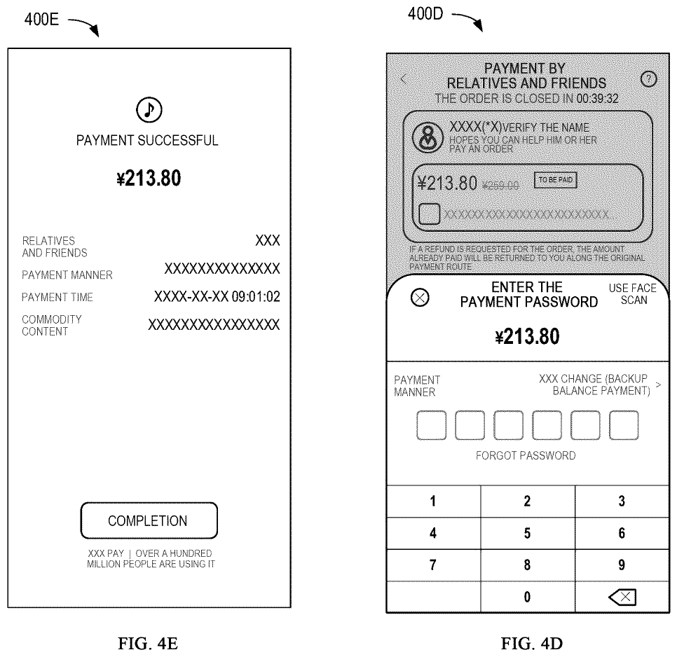

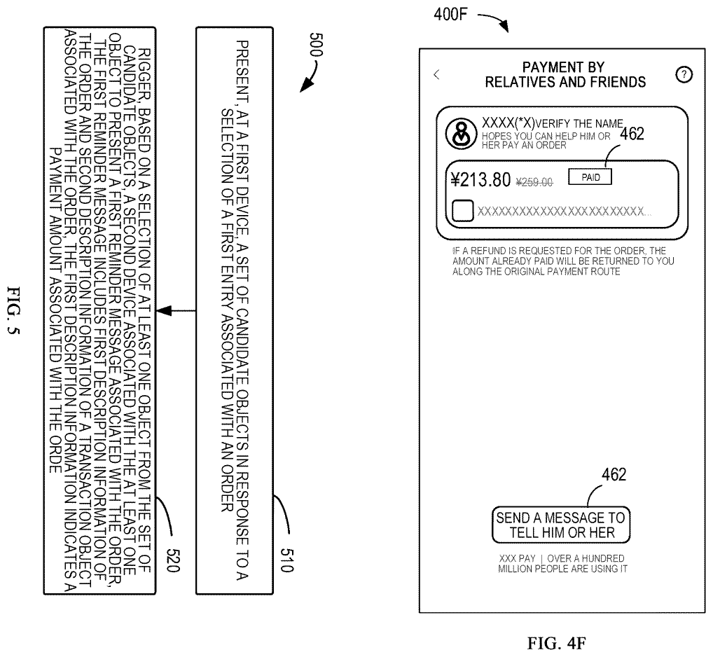

FIG. 3A to FIG. 4F show schematic diagrams of example user interfaces 300A to 400F of a responder according to some embodiments of the present disclosure. It should be understood that the pages shown in the drawings are only examples, and there may actually be various page designs. Each graphic element in the page may have different arrangements and different visual representations, one or more of which may be omitted or replaced, and there may also be one or more other elements. Embodiments of the present disclosure are not limited in this regard. The pages shown in the example user interfaces 300A to 400F may be presented at the second device 140. For the convenience of discussion, the example user interfaces 300A to 400F will be described with reference to the environment 100 of FIG. 1.

In an operation, the second device 140 presents a first reminder message associated with an order in response to receiving, at the first device 120, a selection of a first user associated with the second device 140, the first reminder message including first description information of the order and second description information of a transaction object associated with the order, the first description information indicating a payment amount associated with the order. According to embodiments of the present disclosure, the second device 140 may pay at least a portion of the payment amount associated with the order based on a preset operation for the first reminder message.

The present disclosure has described the first reminder message and the first/second description information in detail. For example, according to various embodiments of the present disclosure, the first reminder message is presented to the second user 130 in an appropriate form. In some embodiments, the first reminder message may be sent to the second device 140 in the form of an instant messaging message. In some embodiments, the first reminder message may be presented to the second device 140 in the form of a pop-up window. In some other embodiments, the first reminder message may be presented to the second device 140 in the form of a system message. In some other embodiments, the first reminder message may be inserted into a current message stream to be played. For example, the second device 140 may insert the first reminder message into a set of media content to be played. In this case, as the second user 130 swipes the screen, the second device 140 may present the first reminder message in the interactive interface. In this case, the second user 130 may choose to process the first reminder message (for example, assist in payment), or may continue to swipe the screen to ignore the first reminder message. This will not be repeated for the sake of brevity.

In some embodiments, the first device 120 is associated with the second user, and presenting the first reminder message associated with the order includes: presenting, in a chat interface of a target chat associated with the second user, a message card corresponding to the first reminder message. In this way, the second user 130 may check the payment request from the first user 110 in time. More importantly, the second user 130 may view the historical interaction with the first user 110 to determine whether to assist the first user 110 in completing the payment of the order.

In some embodiments, the second device 140 updates a style of the message card and/or presents a fourth reminder message associated with the completed payment in the chat interface in response to completing the payment of the at least the portion. In an embodiment, after the second user 130 completes the payment operation, the message card may additionally display a prompt message of “paid”. In another example embodiment, after the second user 130 completes the payment operation, a new message may be generated in the chat window to indicate that the payment has been completed.

In some embodiments, presenting the first reminder message associated with the order includes: presenting, in a viewing interface of an information flow, a content item corresponding to the first reminder message as part of the information flow. As an example embodiment, the first reminder message is an information card. In operation, the information card may be inserted into a current information flow to be browsed by the user (for example, the information flow may include a set of media content to be played, including but not limited to, video, audio, pictures, music, etc.). In this case, when the user switches the browsed message, for example, by swiping the screen, the information card of the first reminder message may be presented. In this way, the presentation of the first reminder message will be more natural. Further, when the first reminder message is inserted into the information flow as an information card, the user may choose to process the first reminder message, or may ignore the reminder message in a conventional manner (for example, by swiping the screen). In other words, with the above implementation, when the user is browsing the information flow, the current browsing operation will not be interrupted by receiving the first reminder message. Therefore, the interference of the first reminder message to the user is minimized.

In some embodiments, paying at least a portion of the payment amount associated with the order based on the preset operation for the first reminder message includes: paying, in response to a first operation on the first reminder message, at least a portion of the payment amount associated with the order, the first operation including a selection of a first payment entry in the first reminder message. In an example embodiment, a quick payment control may be presented in association with the first reminder message. In response to the activation of the quick payment control, the payment of the order is directly triggered. In the traditional solution, the prompt message only includes the amount to be paid, and the user needs to first view the order details, and then trigger the payment operation after confirming the detailed information, that is, the traditional solution requires multiple page jumps. According to the disclosed embodiments, the first prompt message may carry the second description information. In this case, the second user 130 may determine whether to assist in completing the payment of the order based on the second description information. By presenting the quick payment control in association with the first reminder message, the second user 130 may directly assist in completing the payment of the order without performing an additional page jump, thereby simplifying the electronic payment process.

In some embodiments, paying at least a portion of the payment amount associated with the order based on the preset operation for the first reminder message includes: presenting, in response to a second operation on the first reminder message, a viewing interface of the order, the viewing interface including a second payment entry associated with the order; and paying, based on a selection of the second payment entry, at least a portion of the payment amount associated with the order. In this way, the second user 130 may further determine order information.

As briefly discussed in the present disclosure, the first user 110 may set various parameters involved in the candidate object and the amount to be paid. Similar to the first user 110, the second user 130 may also set payment parameters, including but not limited to, payment amount, payment object, and the like. In some embodiments, the payment amount is a first payment amount, and paying at least a portion of the payment amount associated with the order based on the preset operation for the first reminder message includes: determining, based on a received user input, a second payment amount associated with the second device 140, the second payment being less than or equal to the first payment amount; and paying the second payment amount associated with the order. For example, if the total amount to be paid is 60 yuan, the second user 130 may set the payment to 30 yuan. In this way, the second user 130 may flexibly determine the amount of the payment amount to be assisted. As discussed above, the order may involve one or more objects. When the order involves multiple objects, the second user 130 may choose to assist in paying for some of the multiple objects. For example, an order to be paid involves a first object, a second object, and a third object. The second user 130 may select the first object to assist in completing the payment of the first object.

In some embodiments, when the order involves multiple objects, presenting the first reminder message may include multiple selection controls corresponding to the multiple objects. The second user 130 may select an object to assist in paying for by activating the selection control of the object. Alternatively, in some embodiments, when the order involves multiple objects, the second user 130 may activate the first reminder message to enter the details page. In the details page, the second user 130 may view and select an object to assist in paying for.

For a better understanding of the above process, further illustration will be made in conjunction with the example interfaces of FIG. 3A to FIG. 3F. In the example interface 300A, a message card 302 is presented, which includes the first description information and the second description information. Further, the example interface 300A includes a quick payment control 304. In response to a trigger on the quick payment control 304, the second user 130 may directly perform a payment operation for the order.

In some embodiments, by triggering the first reminder message, the details of the order may be viewed, as shown in the example interface 300B. The example interface 300B may include a further description 314 of the order. In response to the confirmation of the order, for example, activating a confirmation control 314, the payment for the order may be activated. According to the embodiments of the present disclosure, the loading progress of the payment page may be presented, see the example interface 300C, which presents a prompt message 323 indicating that the payment page is being loaded/the payment request is being processed. In the example interface 300D, the second user 140 may input a payment password to complete the payment operation. Further, the second device 140 may present the payment status of the order, for example, in payment, completed, payment failed, and the like. See the example interface 300E, which indicates that the current order has been paid.

In some embodiments, the second device 140 updates a style of the message card and/or presents a fourth reminder message associated with the completed payment in the chat interface in response to completing the payment of at least the portion. See the example interface 300F, after the second user 130 completes the payment operation, a new message 388 may be generated in the chat window to indicate that the payment has been completed.

Further see the example interfaces of FIG. 4A to FIG. 4F for further illustration. In the example interface 400A, a first reminder message 410 is presented, which includes the first description information and the second description information. Further, the example interface 400A includes a quick payment control 412. In response to a trigger on the quick payment control 412, the second user 130 may directly perform a payment operation for the order. Alternatively, the example interface 400A includes a detail viewing control 411. In response to a trigger on the detail viewing control 411, the second user 130 may further view the details of the order.

In some embodiments, by triggering the detail viewing control 411, the details of the order may be viewed, as shown in the example interface 400B. The example interface 400B may include a further description 413 of the order. In response to the confirmation of the order, for example, activating a confirmation control 415, the payment for the order may be activated. According to the embodiments of the present disclosure, the loading progress of the payment page may be presented, see the example interface 400C, which presents a prompt message 423 indicating that the payment page is being loaded/the payment request is being processed. In the example interface 400D, the second user 140 may input a payment password to complete the payment operation. Further, the second device 140 may present the payment status of the order, for example, in payment, completed, payment failed, and the like. See the example interface 400E, which indicates that the current order has been paid.

In some embodiments, the second device 140 may notify the first user 110 in response to completing the payment of the at least the portion. See the example interface 400F, after the second user 130 completes the payment operation, a notification control 462 may be activated. In response to the activation of the notification control 462, a notification message may be sent to the first user 110. Similar to the first reminder message, the notification message may also be presented at the first device 120 in various ways.

It should be understood that the operations at the first device 120 and the second device 140 are corresponding. Although some implementation operations are only described at the first device 120, it should be understood that the corresponding operations should be performed at the second device 140. Correspondingly, although some implementation operations are only described at the second device 140, it should be understood that the corresponding operations should be performed at the first device 140. The corresponding operations are not repeated for the sake of brevity.

### Example Process

FIG. 5 shows a flowchart of an example process 500 of electronic payment according to some embodiments of the present disclosure. The process 500 may be implemented at the first device 120. The process 500 is described below with reference to FIG. 1.

At block 510, the first device presents a set of candidate objects in response to a selection of a first entry associated with an order.

At block 520, the first device triggers, based on a selection of at least one object from the set of candidate objects, a second device associated with the at least one object to present a first reminder message associated with the order, the first reminder message includes first description information of the order and second description information of a transaction object associated with the order, the first description information indicating a payment amount associated with the order.

In some embodiments, the second description information includes at least one of: an image identification of the transaction object, or a text description of the transaction object.

In some embodiments, the first device triggers, in response to the order being unpaid and based on a selection of an additional object from the set of candidate objects, a third device associated with the additional object to present a third reminder message associated with the order.

In some embodiments, the first reminder message further indicates time information associated with payment the order.

In some embodiments, the first device presents a message card associated with the order in a chat interface of a target chat based on the selection of the at least one object, the target chat being associated with the at least one object, the message card presenting the first description information and the second description information.

In some embodiments, the first reminder message includes a payment entry for paying the order.

In some embodiments, the first device presents a fifth reminder message associated with a target user in response to that the order is paid by the target user associated with the at least one object.

In some embodiments, the at least one object is associated with a plurality of users, and each user of the plurality of users is associated with a partial payment amount of a total payment amount of the order.

In some embodiments, the partial payment amount associated with a user is determined randomly; or the partial payment amount associated with a user is determined based on a received configuration operation.

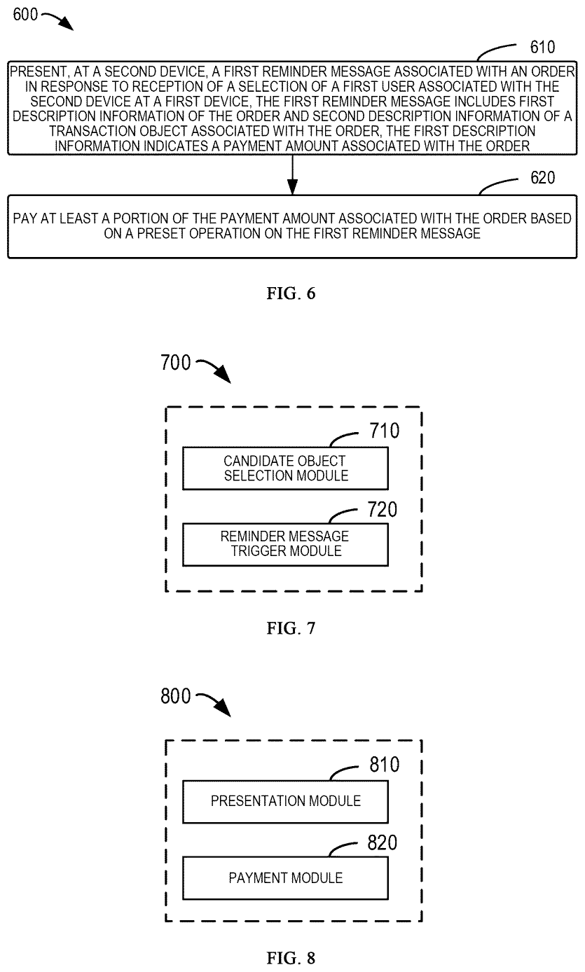

FIG. 6 shows a flowchart of an example process 600 of electronic payment according to some embodiments of the present disclosure. The process 600 may be implemented at the second device 140. The process 600 is described below with reference to FIG. 1.

At block 610, the second device presents, at a second device, a first reminder message associated with an order in response to reception of a selection of a first user associated with the second device at a first device, the first reminder message includes first description information of the order and second description information of a transaction object associated with the order, the first description information indicating a payment amount associated with the order.

At block 620, the second device pays at least a portion of the payment amount associated with the order based on a preset operation on the first reminder message.

In some embodiments, the first device is associated with a second user, and presenting the first reminder message associated with the order includes: presenting, in a chat interface of a target chat associated with the second user, a message card corresponding to the first reminder message.

In some embodiments, the second device updates a style of the message card and/or presents a fourth reminder message associated with the completed payment in the chat interface in response to completing the payment of the at least the portion.

In some embodiments, presenting the first reminder message associated with the order includes: presenting, in a viewing interface of an information flow, a content item corresponding to the first reminder message as a portion of the information flow.

In some embodiments, paying at least a portion of the payment amount associated with the order based on the preset operation for the first reminder message includes: paying, in response to a first operation for the first reminder message, the at least the portion of the payment amount associated with the order, the first operation including a selection of a first payment entry in the first reminder message.

In some embodiments, paying at least the portion of the payment amount associated with the order based on the preset operation on the first reminder message includes: presenting, in response to a second operation on the first reminder message, a viewing interface of the order, the viewing interface including a second payment entry associated with the order; and paying, based on a selection of the second payment entry, the at least the portion of the payment amount associated with the order.

In some embodiments, the payment amount is a first payment amount, and paying at least the portion of the payment amount associated with the order based on the preset operation for the first reminder message includes: determining, based on a received user input, a second payment amount associated with the second device, the second payment being less than or equal to the first payment amount; and paying the second payment amount associated with the order.

### Example Apparatuses and Devices

Embodiments of the present disclosure further provide corresponding apparatuses for implementing the above methods or processes. FIG. 7 shows a schematic structural block diagram of an example apparatus 700 for electronic payment according to some embodiments of the present disclosure. The apparatus 700 may be implemented as or included in the first device 120. Each module/component in the apparatus 700 may be implemented by hardware, software, firmware, or any combination thereof.

As shown in FIG. 7, the apparatus 700 includes: a candidate object selection module 710 configured to present, at a first device, a set of candidate objects in response to a selection of a first entry associated with an order; and a reminder message trigger module 720 configured to trigger, based on a selection of at least one object from the set of candidate objects, a second device associated with the at least one object to present a first reminder message associated with the order, the first reminder message includes first description information of the order and second description information of a transaction object associated with the order, the first description information indicating a payment amount associated with the order.

In some embodiments, the second description information includes at least one of: an image identification of the transaction object; or a text description of the transaction object.

In some embodiments, the apparatus 700 further includes a third reminder message trigger module configured to trigger, in response to the order being unpaid and based on a selection of an additional object from the set of candidate objects, a third device associated with the additional object to present a third reminder message associated with the order.

In some embodiments, the first reminder message further indicates time information associated with paying the order.

In some embodiments, the apparatus 700 further includes a message card presentation module configured to present a message card associated with the order in a chat interface of a target chat based on the selection of the at least one object, the target chat is associated with the at least one object, the message card presenting the first description information and the second description information.

In some embodiments, the first reminder message includes a payment entry for paying the order.

In some embodiments, the apparatus 700 further includes a fifth reminder message presentation module configured to present a fifth reminder message associated with a target user in response to that the order is paid by the target user associated with the at least one object.

In some embodiments, the at least one object is associated with a plurality of users, and each user of the plurality of users is associated with a partial payment amount of a total payment amount of the order.

In some embodiments, the partial payment amount associated with a user is determined randomly; or the partial payment amount associated with a user is determined based on a received configuration operation.

Embodiments of the present disclosure further provide corresponding apparatuses for implementing the above methods or processes. FIG. 8 shows a schematic structural block diagram of an example apparatus 800 for electronic payment according to some embodiments of the present disclosure. The apparatus 800 may be implemented as or included in the second device 140. Each module/component in the apparatus 800 may be implemented by hardware, software, firmware, or any combination thereof.

As shown in FIG. 8, the apparatus 800 includes: a presentation module 810 configured to present, at a second device, a first reminder message associated with an order in response to reception of a selection of a first user associated with the second device at a first device, the first reminder message includes first description information of the order and second description information of a transaction object associated with the order, the first description information indicating a payment amount associated with the order; and a payment module 820 configured to pay at least a portion of the payment amount associated with the order based on a preset operation on the first reminder message.

In some embodiments, the first device is associated with a second user, and presenting the first reminder message associated with the order includes: presenting, in a chat interface of a target chat associated with the second user, a message card corresponding to the first reminder message.

In some embodiments, the apparatus 800 further includes a fourth reminder message presentation module configured to update a style of the message card and/or presenting a fourth reminder message associated with the completed payment in the chat interface in response to completing the payment of the at least the portion.

In some embodiments, the presentation module 810 is further configured to present, in a viewing interface of an information flow, a content item corresponding to the first reminder message as a portion of the information flow.

In some embodiments, the payment module 820 is further configured to pay, in response to a first operation for the first reminder message, the at least the portion of the payment amount associated with the order, the first operation includes a selection of a first payment entry in the first reminder message.

In some embodiments, the payment module 820 is further configured to present, in response to a second operation on the first reminder message, a viewing interface of the order, the viewing interface includes a second payment entry associated with the order; and pay, based on a selection of the second payment entry, the at least the portion of the payment amount associated with the order.

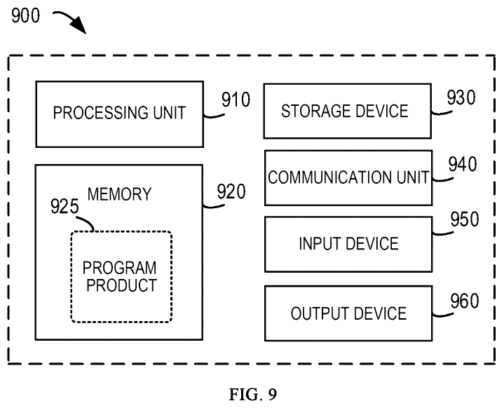

In some embodiments, the payment module 820 is further configured to determine, based on a received user input, a second payment amount associated with the second device, the second payment being less than or equal to the first payment amount; and pay the second payment amount associated with the order. As shown in FIG. 9, the electronic device 900 is in the form of a general-purpose electronic device. The components of the electronic device 900 may include, but are not limited to, one or more processors or processing units 910, a memory 920, a storage device 930, one or more communication units 940, one or more input devices 950, and one or more output devices 960. The processing unit 910 may be an actual or virtual processor, and may perform various processing based on a program stored in the memory 920. In a multi-processor system, multiple processing units perform computer-executable instructions in parallel to improve the parallel processing capability of the electronic device 900.

The electronic device 900 typically includes multiple computer storage media. Such media may be any available media accessible by the electronic device 900, including but not limited to volatile and non-volatile media, and removable and non-removable media. The memory 920 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 930 may be any removable or non-removable media, and may include a machine-readable media such as a flash drive, a magnetic disk, or any other media, which may be used to store information and/or data and may be accessed within the electronic device 900.

The electronic device 900 may further include other removable/non-removable, volatile/non-volatile memory media. Although not shown in FIG. 9, it is possible to provide a magnetic disk drive for reading from or writing into removable and non-volatile magnetic disks (such as a “floppy disk”), and an optical disk drive for reading from or writing into removable and non-volatile optical disks. In these cases, each drive may be connected to the bus (not shown) by one or more data medium interfaces. The memory 920 may include a computer program product 925, which has one or more program modules configured to perform various methods or acts of the various embodiments of the present disclosure.

The communication unit 940 enables communication with other electronic devices through a communication medium. Additionally, the functions of the components of the electronic device 900 may be implemented by a single computing cluster or multiple computing machines, which may communicate through a communication connection. Therefore, the electronic device 900 may use a logical connection with one or more other servers, a network personal computer (PC), or another network node to operate in a networked environment.

The input device 950 may be one or more input devices, such as a mouse, a keyboard, a tracking ball, etc. The output device 960 may be one or more output devices, such as a display, a speaker, a printer, etc. The electronic device 900 may also communicate with one or more external devices (not shown) as needed through the communication unit 940, the external devices such as a storage device, a display device, etc., and communicate with one or more devices that enable the user to interact with the electronic device 900, or communicate with any devices (such as a network card, a modem, etc.) that enable the electronic device 900 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product, the computer program product being tangibly stored on a non-transitory computer-readable medium and including computer-executable instructions, and the computer-executable instructions being executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to the processing unit of a general-purpose computer, a special-purpose computer, or other programmable data processing apparatus to produce a machine, so that when these instructions are executed by the processing unit of the computer or other programmable data processing apparatus, an apparatus for implementing the functions/actions specified in one or more blocks in the flowcharts and/or block diagrams is produced. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/actions specified in one or more blocks in the flowcharts and/or block diagrams.

The computer-readable program instructions may be loaded onto a computer, another programmable data processing apparatus, or other devices, so that a series of operation steps are performed on the computer, the other programmable data processing apparatus, or the other devices to produce a computer-implemented process, so that the instructions executed on the computer, the other programmable data processing apparatus, or the other devices implement the functions/actions specified in one or more blocks in the flowcharts and/or block diagrams.

The flowcharts and block diagrams in the drawings show the possibly implemented architectures, functions, and operations of the system, the method, and the computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combination of the blocks in the block diagrams and/or flowcharts, may be implemented by a dedicated hardware-based system that performs the specified functions or actions, or may be implemented by a combination of dedicated hardware and computer instructions.

The implementations of the present disclosure have been described above, and the above description is illustrative, non-exhaustive, and not limited to the disclosed implementations. Without departing from the scope and spirit of the described implementations, many modifications and changes will be apparent to those of ordinary skill in the art. The terms used herein are chosen to best explain the principles of the implementations, the practical applications or improvements to the technology in the market, or to enable other those of ordinary skill in the art to understand the implementations disclosed herein.

1. A method for electronic payment, comprising:
presenting, at a first device, a set of candidate objects in response to a selection of a first entry associated with an order; and
triggering, based on a selection of at least one object from the set of candidate objects, a second device associated with the at least one object to present a first reminder message associated with the order, the first reminder message comprising first description information of the order and second description information of a transaction object associated with the order, the first description information indicating a payment amount associated with the order.

2. The method of claim 1, wherein the second description information comprises at least one of:
an image identification of the transaction object, or
a text description of the transaction object.

3. The method of claim 1, further comprising:
triggering, in response to the order being unpaid and based on a selection of an additional object from the set of candidate objects, a third device associated with the additional object to present a third reminder message associated with the order.

4. The method of claim 1, wherein the first reminder message further indicates time information associated with payment of the order.

5. The method of claim 1, further comprising:
presenting a message card associated with the order in a chat interface of a target chat based on the selection of the at least one object, the target chat being associated with the at least one object, the message card presenting the first description information and the second description information.

6. The method of claim 1, wherein the first reminder message comprises a payment entry for paying the order.

7. The method of claim 1, further comprising:
presenting a fifth reminder message associated with a target user in response to that the order is paid by the target user associated with the at least one object.

8. The method of claim 1, wherein the at least one object is associated with a plurality of users, and each user of the plurality of users is associated with a partial payment amount of a total payment amount of the order.

9. The method of claim 8, wherein:
the partial payment amount associated with a user is determined randomly; or
the partial payment amount associated with a user is determined based on a received configuration operation.

10. A method for electronic payment, comprising:
presenting, at a second device, a first reminder message associated with an order in response to reception of a selection of a first user associated with the second device at a first device, the first reminder message comprising first description information of the order and second description information of a transaction object associated with the order, the first description information indicating a payment amount associated with the order; and
paying at least a portion of the payment amount associated with the order based on a preset operation on the first reminder message.

11. The method of claim 10, wherein the first device is associated with a second user, and presenting the first reminder message associated with the order comprises:
presenting, in a chat interface of a target chat associated with the second user, a message card corresponding to the first reminder message.

12. The method of claim 11, further comprising:
updating a style of the message card and/or presenting a fourth reminder message associated with the completed payment in the chat interface in response to completing the payment of the at least the portion.

13. The method of claim 10, wherein presenting the first reminder message associated with the order comprises:
presenting, in a viewing interface of an information flow, a content item corresponding to the first reminder message as a portion of the information flow.

14. The method of claim 10, wherein paying at least the portion of the payment amount associated with the order based on the preset operation on the first reminder message comprises:
paying, in response to a first operation for the first reminder message, the at least the portion of the payment amount associated with the order, the first operation comprising a selection of a first payment entry in the first reminder message.

15. The method of claim 10, wherein paying at least the portion of the payment amount associated with the order based on the preset operation on the first reminder message comprises:
presenting, in response to a second operation on the first reminder message, a viewing interface of the order, the viewing interface comprising a second payment entry associated with the order; and
paying, based on a selection of the second payment entry, the at least the portion of the payment amount associated with the order.

16. The method of claim 10, wherein the payment amount is a first payment amount, and paying at least the portion of the payment amount associated with the order based on the preset operation for the first reminder message comprises:
determining, based on a received user input, a second payment amount associated with the second device, the second payment being less than or equal to the first payment amount; and
paying the second payment amount associated with the order.

17. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
presenting, at a first device, a set of candidate objects in response to a selection of a first entry associated with an order; and
triggering, based on a selection of at least one object from the set of candidate objects, a second device associated with the at least one object to present a first reminder message associated with the order, the first reminder message comprising first description information of the order and second description information of a transaction object associated with the order, the first description information indicating a payment amount associated with the order.

18. The electronic device of claim 17, wherein the second description information comprises at least one of:
an image identification of the transaction object, or
a text description of the transaction object.

19. The electronic device of claim 17, wherein the acts further comprise:
triggering, in response to the order being unpaid and based on a selection of an additional object from the set of candidate objects, a third device associated with the additional object to present a third reminder message associated with the order.

20. The electronic device of claim 17, wherein the first reminder message further indicates time information associated with payment of the order.
